(19) United States
(12) Patent Application Publication
(10) Pub. No.: US 2006/0152048 A1
(43) Pub. Date: Jul. 13, 2006

(54) Forward slippage preventive structure of seat cushion with lifter device

(75) Inventors: Yasuhiko Kamei, Akishima-shi (JP); Masamitsu Minai, Akishima-shi (JP)

Correspondence Address: BROWDY AND NEIMARK, P.L.L.C.;624 NINTH STREET, NW, SUITE 300, WASHINGTON, DC, 20001-5303, US

(73) Assignee: Tachi-S Co., Ltd., Akishima-shi (JP)

(21) Appl. No.: 11/311,127

(22) Filed: Dec. 20, 2005

(30) Foreign Application Priority Data
Jan. 12, 2005 (JP) 2005-004633

(51) Int. Cl. B60N 2/42

(52) U.S. Cl. 297/216.1

(57) ABSTRACT

A forward slippage preventive structure of seat cushion with lifter device, wherein a horizontal bar element, adapted for preventing forward buttocks slippage of seat occupant, is connected with two link members of the lifter device. A reinforcing flange element is formed in either of forward and backward ends of each of two link members in a direction inwardly of a seat cushion frame. Basically, one end portion of the horizontal bar element is connected integrally with such reinforcing flange element and one of the two link members, such that a truss structure is established thereamong. Based thereon, both end portions of the horizontal bar element are connected between two reinforcing flange elements.

### BACKGROUND OF THE INVENTION

1. Field of the Invention

The present invention relates to a seat cushion structure provided with a lifter device, wherein the liter device includes a forward link member movably provided in a forward portion of a seat cushion frame. In particular, the invention is directed to this sort of seat cushion structure having a horizontal bar element which serves to prevent forward slippage of a seat occupant's buttock portion on and along the upper surface of seat cushion in a collision case or the like. Hereinafter, such bar element shall be referred to as “forward slippage preventive horizontal bar element”.

2. Description of Prior Art

In the case of an abrupt deceleration or stop of a vehicle, a passenger on a seat in the vehicle is naturally caused to displace forwardly due to inertia. Such forward displacement of passenger is basically prevented by a seat belt which restrains the passenger to the seat. However, in such an emergency case as a collision, the stop of vehicle is so abrupt that, in spite of the restrain of seat belt, the buttocks portion of the passenger is forcibly slipped or slid forwardly on a seat cushion of the seat and sunk into the upper elastic portion of the seat cushion, with it being of a high likelihood that the lower portion (or buttocks portion) of the passenger will be damaged or injured. This is what is called “forward buttocks slippage phenomenon”.

Hitherto, various attempts have been made to prevent such forward buttocks slippage phenomenon. For example, as disclosed from the Japanese Laid-Open Patent Publication No. 2002-46513, a cross bar is fixedly provided in the seat cushion as a forward buttocks slippage preventive means, the cross bar extending transversely of the forward region of the seat cushion to thereby prevent forward slippage of the passenger's buttocks portion on the seat cushion. Namely, in the case of sudden collision, the passenger's buttocks portion, which is being slipped on and sunk into the seat cushion, is quickly contacted with the cross bar and thus prevented against further forward movement, thereby protecting the lower body portion of passenger.

Incidentally, there is a vehicle seat with a lifter device operable for height adjustment of the seat, as known for instance from the Japanese Laid-Open Patent Publication No. 2001-88589. The lifter device includes a pair of forward link members pivotally connected between a seat cushion frame of the seat and a slide device or other seat adjustment device to be fixed on a floor of vehicle.

The foregoing cross bar, as a forward buttocks slippage preventive means, may be provided to such kind of vehicle seat with lifter mechanism. Namely, the cross bar may be connected between the pair of forward link members of the lifter mechanism. However, even such structure, in the case of abrupt deceleration or stop of vehicle, the forward slippage of passenger as stated above causes a great forward load to the cross bar, which is in turn directly exerted on both two forward link members as an excessive impact thereagainst. As a result thereof, it is highly possible that the two forward link members will be deformed into an undesired inoperative state, or twisted or bent in either of rightward and leftward directions.

Accordingly, the forward buttocks slippage preventive arrangement using the cross rod, as taught in the Japanese Laid-Open Patent Pub. No. 2001-88589, is unsuitable for its direct use with the vehicle seat with lifter mechanism, or can not easily be incorporated therein.

Of course, to simply solve such problem, each of the forward link mechanisms may be formed to have an increased thickness to give it a rigidity to withstand the great load created by the forward buttocks slippage. But, this modification also requires an increase of strength in a pivotal connection point of the forward link member and in other peripheral parts, which will result in an undesired complicated or large structure of vehicle seat.

### SUMMARY OF THE INVENTION

In view of the above-stated drawbacks, it is a purpose of the present invention to provide an improved forward slippage preventive structure of seat cushion with a lifter device, which is of simplified structure and permits direct use of ordinary forward link member of the lifter device therewith.

In order to achieve such purpose, in accordance with the present invention, there is basically provided a forward slippage preventive structure of a seat cushion frame of a vehicle seat in combination with a lifter device operable for height adjustment of the vehicle seat and a floor of vehicle, wherein the lifter device includes a pair of link members pivotally provided between the seat cushion frame and a base means fixed on the floor of vehicle, the pair of link members being disposed on a side forwardly of the vehicle seat, and wherein the vehicle seat includes a seat cushion in which the seat cushion frame is provided,

the forward slippage preventive structure comprising:
one reinforcing flange portion which is formed in one of the pair of link members so as to extend in a direction inwardly of the seat cushion frame;
another reinforcing flange portion which is formed in another of the pair of link members so as to extend in a direction inwardly of the seat cushion frame; and
a horizontal bar element,

wherein the horizontal bar element is connected between the afore-said one and another reinforcing flange portions and extends in a direction transversely of the seat cushion frame and is situated in a locus along which a seat occupant's buttocks portion is to be slipped on the seat cushion and sunk thereinto in a direction forwardly of the seat cushion frame under inertia in a case of collision or the like.

Preferably, one end portion of the horizontal bar element may be integrally connected with either of the afore-said one and another reinforcing flange portions, whereupon a truss structure is established by the afore-said one end portion of the horizontal bar element, the afore-said either of the one and another reinforcing flange portions and one of the pair of link members.

As one aspect of the present invention, the seat cushion frame may include a pair of side frame members each having an inward side facing to a side inwardly of the seat cushion frame, and the horizontal bar element may have two end portions. The horizontal bar element may be at one of the two end portions integrally connected with the one of the pair of link members and the reinforcing flange portion formed in that one of the pair of link members, while being at another of the two end portions integrally connected with that another of the pair of link members and the reinforcing flange portion formed in that another of the pair of link members, in such a manner that each of the two end portions of the horizontal bar element faces to the inward side of each of the pair of side frame members and is disposed adjacent thereto.

Other various features and advantages of the present invention will become apparent from reading of the description, hereinafter, with reference to the accompanied drawings.

### BRIEF DESCRIPTION OF THE DRAWINGS

FIG. 1 is a schematic front view of a forward slippage preventive structure of seat cushion with lifter device in accordance with the present invention;

FIG. 2 is an exploded perspective view showing a principal part of the present invention;

FIG. 3 is a partly broken side view showing one embodiment of the forward slippage preventive structure of seat cushion with lifter device; and

FIG. 4 is a partly broken side view showing another alternative embodiment of the forward slippage preventive structure of seat cushion with lifter device.

### DETAILED DESCRIPTION OF PREFERRED EMBODIMENT OF THE INVENTION

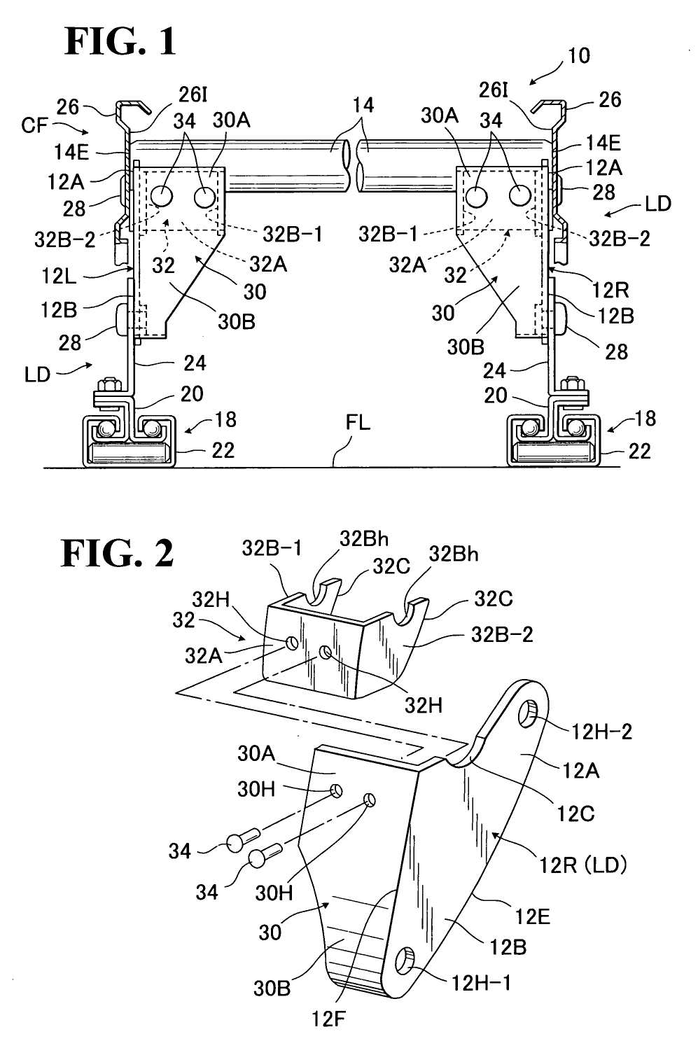

Referring to FIGS. 1 to 4, there is illustrated one preferred embodiment of forward slippage preventive structure of seat cushion frame of vehicle seat, as generally designated by (10), in accordance with the present invention. Designation (CF) denotes a known seat cushion frame used in this structure, which includes a pair of side frame members (26) (26). Designation (16) stands for an ordinary seat cushion which is typically formed by that seat cushion frame (CF) and an upholstery (not shown) covering the seat cushion frame (CF).

While a whole of the vehicle seat is not shown clearly, the vehicle seat per se is of the type provided with a known lifter device (i.e. a seat height adjustment device) which is indicated by the designation (LD). The lifter device (LD) includes a right-side forward link member (12R) and left-side forward link member (12L), as seen from FIG. 1, Of course, the lifter device (LD) includes a right-side backward link member and a left-side forward link member, though not shown.

It is noted that the term, “forward” or “forwardly,” refers to a forward side (F) of the seat cushion (16), whereas the term, “backward” or “backwardly,” refers to a backward side (R) of the seat cushion (16).

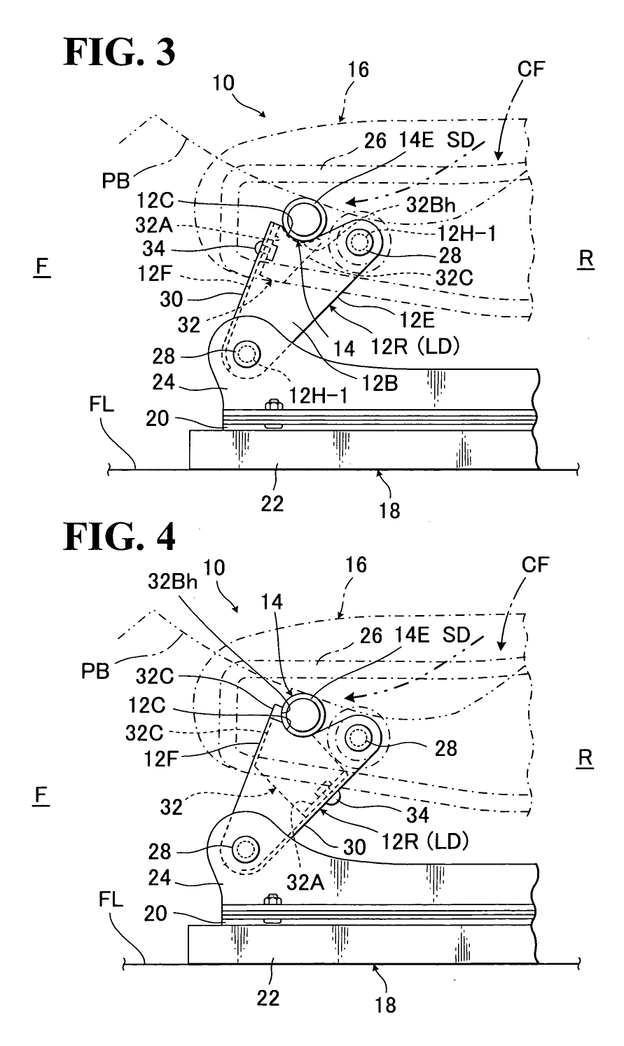

As can readily be understood by any person skill in the art, the lifter device (LD) is operatively connected between the two side frame members (26) of seat cushion frame (CF) and a base means fixed on floor (FL), wherein the base means may be a pair of slide rail devices (18) (18), for example. In this regard, specifically stated, each of the slide rail devices (18) comprises a lower rail member (22) fixed on the floor (FL) and an upper rail member (20) slidably fitted in the lower rail member (22). Designation (24) denotes a seat riser element fixed on each upper rail member (20), which is a support base to which the lower end of each forward link member (12R or 12L) is pivotally connected. Specifically, as understandable from FIG. 3 in conjunction with FIG. 1, each forward link member (12R or 12L) has an upper end portion pivotally connected via a shaft (28) with the inward vertical planar surface (26I) of the side frame member (26) and a lower end portion pivotally connected via a shaft (28) with the inward vertical planar surface of the seat riser element (24). Referring to FIG. 2 which shows the right-side forward link member (12R) though, it is to be understood therefrom that the upper and lower end portions of each of the two forward link members (12R) (12L) are respectively formed with an upper bearing hole (12H-2) through which a shaft (28) passes and a lower bearing hole (12H-1) through which a shaft (28) passes.

In accordance with the present invention, there is provided a simplified and robust structure for connecting a forward slippage preventive horizontal bar element (14) integrally with the foregoing two forward link members (12R) (12L). The forward slippage preventive horizontal bar element (14) itself is known in the art, as stated in the description of prior art, which is normally provided in the seat cushion frame (CF) in a horizontal manner so as to extend transversely of the seat cushion frame (CF), thereby serving to prevent the previously stated forward buttocks slippage phenomenon. Briefly stated, in accordance with the present invention, a reinforcing flange element (30) is formed integrally with the conventional forward link member (12R or 12L) and each end of the forward slippage preventive horizontal bar element (14) is integrally fixed to the upper end of that forward link member (12R or 12L) so as to adjacently face to the inward vertical planar surface (26I) of side frame member (26). The forward slippage preventive horizontal bar element (14) may be formed from a tubular rigid material as shown.

More specifically, as best shown in FIG. 2, a reinforcing flange element (30) may be formed as an inwardly bent extension of the forward link member (12R or 12L). That is, a predetermined extension may be formed in the forward link member (12R or 12L) and bent at one end thereof by a right angle from a forward vertical line (at 12F) of the forward link member (12R or 12L) in a direction inwardly of the seat cushion frame (CF), thereby defining that reinforcing flange element (30).

The reinforcing flange element (30) per se is shown as being formed in a downwardly convergent or tapered shape which has an upper wide area (30A) and a lower narrow area (30B). Formed in the upper wide area (30) are a pair of securing holes (30H) (30H) through which a pair of securing bolts or rivet pin passes, respectively, as will be stated later.

In the present invention, a recessed portion (12C), which is so adapted that one end of the forward slippage preventive horizontal bar element (14) is received and fixed therein as by welding, is formed in the upper edge of the forward link member (12R or 12L) at a point adjacent to the upper wide area (30) of reinforcing flange element (30). Strictly stated, such recessed portion (12C) is also disposed lower than the upper edge of that upper wide area (30).

Referring again to FIG. 2, there is provided a connecting piece (32) adapted for firmly connecting the forward slippage preventive horizontal bar element (14) with the upper wide area (30A) of the reinforcing flange element (30). As shown, the connecting piece (32) is formed to have a securing wall portion (32A), and a pair of first and second wall portions (32B-1) (32B-2) which extend by a right angle from the securing wall portion (32A). Each of the first and second wall portions (32B-1) (32B-2) has, formed in its upper edge, a recessed portion (32Bh) which corresponds in shape and position to the foregoing recessed portion (12C) formed in the forward link member (12R or 12L). Both two recessed portions (32Bh) are so adapted that one end portion of the forward slippage preventive horizontal bar element (14) are received and fixed therein as by welding.

Reference being now made to FIGS. 1 to 3, a description will be made as to how the forward slippage preventive horizontal bar element (14) is integrally fixed to the forward link member (12R or 12L). It is however noted that assembling steps are to be followed in the same manner for both of the right-side and left-side portions of such horizontal bar element (14) as well as the right-side and left-side forward link members (12R) (12L), and therefore, a description will be given only with regard to the right-side link member (12R), and its associated peripheral elements (i.e. the right-side end portion (at 14E) of the horizontal bar element (14) and the right-side auxiliary connecting piece (32), as viewed from FIGS. 3 and 4) for the sake of simplicity in description.

At first, one end portion of the forward slippage preventive horizontal bar element (14) is firmly and integrally welded to both two recessed portions (32Bh) of the connecting piece (32). Thereafter, the securing wall portion (32A) and second wall portion (32B-1) of the auxiliary connecting piece (32) are contacted with an inward side of the upper wide area (30A) of the reinforcing plate element (30) and an inward side of the upper region (12A) of the forward link member (12R), respectively. Then, the two securing rivet pins (34) (34) of rigid material are each inserted through the respective two aligned holes (30H) (32H) and riveted, so that the one end portion connecting piece (32) is firmly and integrally attached to both reinforcing plate element (30) and forward link member (12R). It is noted here that the two recessed portions (32Bh) of connecting pieces (32) are all in alignment with the recessed portion (12C) of the forward link member (12R), so that the end of the bar element (14) is received and located in that recessed portion (12C).

It is observed from FIGS. 1 and 3 that the upper region (12A) of the forward link member (12R) is disposed at the inward side (261) of the side frame member (26), whereas on the other hand, the lower region (12B) thereof is disposed at the inward side of the seat riser element (24).

As also understandable form the FIGS. 1 and 3, the end portion (at 14E) of the forward slippage preventive horizontal bar element (14) is firmly and integrally welded to all the foregoing securing recessed portions (32Bh) (12C), such that the extremity (14E) thereof is disposed adjacent to the inward side (26I) of the side frame member (26). As best seen in FIG. 3, that particular horizontal bar element (14) is situated in a locus (SD) along which a seat occupant's buttock portion (PB) is to be slipped forwardly on the upper surface of the seat cushion (16) and sunk into the seat cushion (16) under inertia in the case of collision or the like, thereby preventing such forward slippage of occupant's buttock portion (PB).

In the present embodiment, both reinforcing flange element (30) and connecting piece (32) are disposed at the forward side of the forward link member (12R or 12L).

With this structure, it is seen that the forward slippage preventive horizontal bar element (14), reinforcing flange element (30), and forward link member (12R or 12L) establish a truss structure. This particular truss structure is indeed sufficient to resist and withstand forward and backward great load as well as rightward and leftward great load which are applied to that horizontal bar element (14) from a seat occupant in a collision case or the like.

It is further appreciated that a forward great load applied from the above-discussed forward slippage phenomenon as indicated by (SD) to the foregoing horizontal bar element (14) is first dispersed to each of the first and second wall portions (32B-1) (32B-2) of connecting piece (32), then dispersed into the upper wide area (30A) of reinforcing flange element (30), and finally dispersed along the vertical direction of the reinforcing flange element (30) to each of the upper and lower pivotal points (at 28 and 28) of the forward link member (12R or 12L). The same goes for a backward load applied to the bar element (14). Such load dispersion effect, in addition to the truss structure, insures to reduce the load to a lowest possible degree sufficient to protect the forward link member (12R or 12L) against deformation in forward and backward directions. In this connection, the reinforcing flange element (30) is tapered downwardly, which advantageously reduces its area and weight and therefore avoids undesired increase of weight of a whole of seat cushion frame (CF).

It is still further appreciated that, when a lateral great load is applied to the forward slippage preventive horizontal bar element (14) in a direction transversely thereof, the reinforcing flange element (30), which extends in the same direction with that lateral great load, serves to prevent the forward link member (12R or 12L) against deformation in either of rightward and leftward directions, and further, the end (14E) of the horizontal bar element (14) is brought to contact with the inward side (26I) of the side frame member (26), which therefore, in addition to the truss structure, insures to protect the forward link member (12R or 12L) against any deformation or twist in rightward and leftward directions.

With the foregoing novel structure, it is possible to increase the strength and rigidity of the forward link member (12R or 12L), without need to increase its thickness, so that a simplified and small structure of forward slippage preventive structure (10) is attainable.

Furthermore, the forward slippage preventive horizontal bar element (14) is directly connected between the right and left forward link members (12R) (12L), thereby serving as a connecting rod therebetween as well, in contrast to the prior art which requires providing another connecting rod between the two link members. This effectively leads to a great reduction of constituent parts as well as the costs involved, and also achieves much simplified forward slippage preventive structure in the seat cushion frame (CF).

FIG. 4 shows another alternative embodiment, according to which, instead of the above-described first embodiment, the reinforcing flange element (30) may be formed in the backward end (12E) of the forward link member (12R or 12L) so as to extend in a direction inwardly of the seat cushion frame (CF). In this case, the securing wall portion (32A) of connecting piece (32) may be integrally fixed to the inward side of the upper wide area (30A) of the reinforcing flange element (30) via the two rivet pins (34). Of course, prior thereto, the end portion of the forward slippage preventive horizontal bar element (14) is welded to the two recessed portions (32Bh) of connecting piece (32) in the same way as previously described. Since all the processes for assembling the present embodiment are basically identical to those of the foregoing first embodiment, any further description thereon is omitted for the sake of simplicity. This particular second embodiment attains all the same features and advantages described above.

While having describe the present invention so far, it should be understood that the invention is not limited to the illustrated embodiments, but any modification, replacement and addition may be applied thereto without departing from scopes of the appended claims. Basically, the forward slippage preventive structure of the present invention is applied to a front seat, but it may be applied to a rear seat.

What is claimed is:

1. A forward slippage preventive structure of a seat cushion frame of a vehicle seat in combination with a lifter device operable for height adjustment of said vehicle seat and a floor of vehicle, wherein said lifter device includes a pair of link members pivotally provided between said seat cushion frame and a base means fixed on said floor of vehicle, said pair of link members being disposed on a side forwardly of said vehicle seat, and wherein said vehicle seat includes a seat cushion in which said seat cushion frame is provided,
said forward slippage preventive structure comprising:
one reinforcing flange element which is formed in one of said pair of link members so as to extend in a direction inwardly of said seat cushion frame;
another reinforcing flange element which is formed in another of said pair of link members so as to extend in a direction inwardly of said seat cushion frame; and
a horizontal bar element,
wherein said horizontal bar element is connected integrally between said one and another reinforcing flange elements and extends in a direction transversely of said seat cushion frame and is situated in a locus along which a seat occupant's buttocks portion is to be slipped on said seat cushion and sunk thereinto in a direction forwardly of said seat cushion frame under inertia in a case of collision or the like.

2. The forward slippage preventive structure as claimed in claim 1, wherein one end portion of said horizontal bar element is integrally connected with either of said one and another reinforcing flange elements, whereupon a truss structure is established by said one end portion of said horizontal bar element, said either of said one and another reinforcing flange elements and one of said pair of link members.

3. The forward slippage preventive structure as claimed in claim 1, wherein each of said pair of link members has a forward end facing to a side forwardly of said seat cushion frame and a backward end facing to a side backwardly of the seat cushion frame, and wherein each of said one and another reinforcing flange elements is formed in said forward end of said each of said pair of link members.

4. The forward slippage preventive structure according to claim 3, wherein said each of said one and another reinforcing flange elements is formed in said backward end of said each of said pair of link members.

5. The forward slippage preventive structure as claimed in claim 1, wherein one end portion of said horizontal bar element is integrally connected, via a connecting means, with either of said one and another reinforcing flange portions, whereupon a truss structure is established by said one end portion of said horizontal bar element, said either of said one and another reinforcing flange portions and one of said pair of link members.

6. The forward slippage preventive structure according to claim 5, wherein said connecting means comprises a connecting piece having a securing portion and a pair of first and second portions extending from said securing portion, wherein said one end portion of said horizontal bar element is integrally and fixedly connected with both said pair of first and second portions of said connecting piece, and wherein said securing portion of said connecting piece is integrally fixed to either of said one and another reinforcing flange elements.

7. The forward slippage preventive structure as claimed in claim 1, wherein said seat cushion frame includes a pair of side frame members each having an inward side facing to a side inwardly of said seat cushion frame, wherein said horizontal bar element has two end portions, and wherein said horizontal bar element is at one of said two end portions thereof integrally connected with said one of said pair of link members and said one reinforcing flange element formed in said one of said pair of link members, while being at another of said two end portions thereof integrally connected with said another of said pair of link members and said another reinforcing flange element formed in said another of said pair of link members, in such a manner that each of said two end portions of said horizontal bar element is disposed adjacent to said inward side of each of said pair of side frame members.

8. The forward slippage preventive structure as claimed in claim 1, wherein said one reinforcing flange element is so formed to have a wide area and a narrow area, and likewise, said another reinforcing flange element is so formed to have a wide area and a narrow area, and wherein said horizontal bar element is connected between said wide area of said one reinforcing flange element and said wide area of said another reinforcing flange element.
